(19) United States
(12) Patent Application Publication
(10) Pub. No.: US 2008/0103829 A1
(43) Pub. Date: May 1, 2008

(54) System and method for trading personal health data

(76) Inventors: Michael Mankopf, Mohrendorf (DE); Sultan Haider, Erlangen (DE); Georg Heidenreich, Erlangen (DE); Klaus Abraham-Fuchs, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/588,711

(22) Filed: Oct. 26, 2006

(51) Int. Cl. H04L 9/00; G06F 19/00

(52) U.S. Cl. 705/3; 705/51; 726/1

(57) ABSTRACT

A system and appertaining method are provided for authorizing and transmitting patient medical data by an owner of the data to a third party. Accordingly, a consent request module that is provided with information related to the third party via which the owner enters information related to user authorization data that may be used by the third party. A contract module is utilized to enter contractual information related to terms, conditions and compensation for providing the medical data to the third party. Finally, a search and filter module comprises rules for filtering the medical data and a mechanism for accessing the filtered medical data from the owner medical data store. A communications link permits access to the filtered medical data by the third party.

### BACKGROUND

The present invention relates to a system and method for trading personal health data.

In many situations, pre-processed and classified clinical data are of value to a third party. This data may comprise, e.g.:
data on consumption of pharmaceutical products for market analysis in the pharma market, or for logistics planning for pharmacies
clinical outcomes or clinical reports for benchmarking or planning purposes for a health insurance company or other health cost payor institution.
diagnostic data for identifying patients which are suitable to be included in a clinical study
epidemiologic data to support planning and decision making in public health care administration institutions.

Such data are increasingly available today in digital form in Health Care IT systems such as Hospital Information Systems (HIS), Electronic Patient Records (EPR) or Electronic Health Cards (EHC). Owners of the data are either health care institutions, the physicians within the health care institutions, and/or the patient. Health care data owners have to give consent if the data are to be used in any other context than the medical procedure within which they have been created. In case the data are of commercial value, the owners may expect a payment for transfer of rights to their data to a third party. Conversely, third party users of clinical data such as pharmaceutical companies, clinical research organizations, or health care payors may be interested to pay compensation for getting access to such data.

The major challenge thus is to discover the existence of relevant data and to establish a contract between the data user and the data owner in an easy and economical way such that an exchange of the information is profitable for both sides. The present invention provides a solution to this challenge with respect to data owned by the patient.

Business involving clinical data is currently in its infancy, and is by no means fully automated. Examples for preliminary automation can be found in international patent publication no. WO 2005/081165, which discloses that a cross-check is made if clinical workflow data are compatible with a clinical study protocol. A further example can be found in international patent publication no. WO 2005/081163 which discloses that a search is made for patients which satisfy criteria for inclusion in a clinical study.

A vast amount of health care data is owned by the patient, either individually by the patient or together with the responsible physician. Such data include, for example, measurement values of physiological parameters, such as blood pressure, ECG, or blood glucose. If the patient has recorded such data by himself in a homecare scenario, the data are owned solely by him. If such data have been recorded in a clinical environment by a health care professional, the patient will often have to give his consent for use of the data in a context other than the medical diagnostic or therapeutic procedure. Ownership relationships of such data may be different in health care systems of different countries. Increasingly, such data are recorded, stored and transferred as digital data, and are accessible from a variety of entry points into a networked health care system IT.

An especially suitable and currently emerging entry point for health data access is the electronic health card (EHC), as well as the respective reader stations where the card is inserted in order to read data from the card, store data to the card, or get access to remote patient data through an authorization procedure which uses authorization information on the card. Especially the latter two use cases of the EHC imply that the EHC reader station is networked to one or more health care data repositories or respective health care institutions. This new emerging technology provides a starting base for the invention to mediate a commercial exchange of health care data between a patient and a third party.

### SUMMARY

The system and method described in the invention enables a new type of business with personal health data, where the patient controls the business relationships himself, and benefits directly from value of his personal data for third parties.

Accordingly, the invention relates to a method for authorizing and transmitting patient medical data by an owner of the data to a third party, comprising: initiating a consent request to provide patient medical data to a third party by an owner of the medical data; storing information related to the third party; storing information related to a location of the medical data to transfer to the third party; storing information related to access authorization of the medical data to transfer to the third party; electronically creating a contract having terms defining and regulating conditions for use rights of the third party for the medical data and defining compensation for use of the medical data; storing the contract terms; searching and filtering for relevant patient medical data consistent with the contract terms, thereby producing filtered medical data; and transmitting the filtered medical data to the third party.

The invention further relates to an appertaining system for authorizing and transmitting patient medical data by an owner of the data to a third party, comprising: a user input device, and a user display device; a consent request module that is provided with information related to the third party via which the owner enters information related to user authorization data; an owner medical data store comprising medical data associated with the owner; a user authorization data store comprising the user authorization data entered by the user; a contract module via which the owner enters contract terms and conditions for the third party; a search and filter module comprising rules for filtering the owner medical data and a mechanism for accessing the filtered medical data from the owner medical data store; and a communications link via which the third party accesses the filtered medical data.

### DESCRIPTION OF THE DRAWINGS

The invention is described in more detail according to various preferred embodiments illustrated by the figures and appertaining description below.

FIGS. 1A, B are system block diagrams illustrating various components of the system; and

FIGS. 2A, B are flowchart portions illustrating an embodiment of the procedure.

### DETAILED DESCRIPTION OF THE PREFERRED EMBODIMENTS

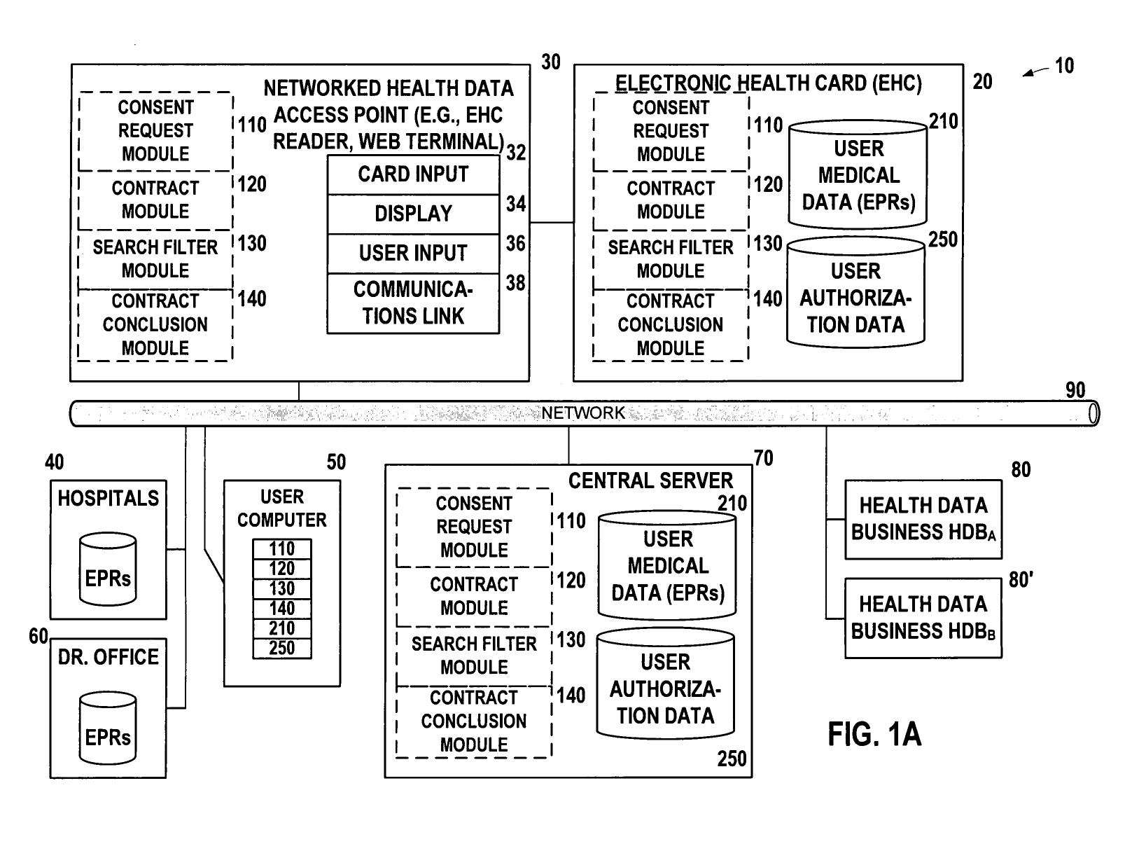

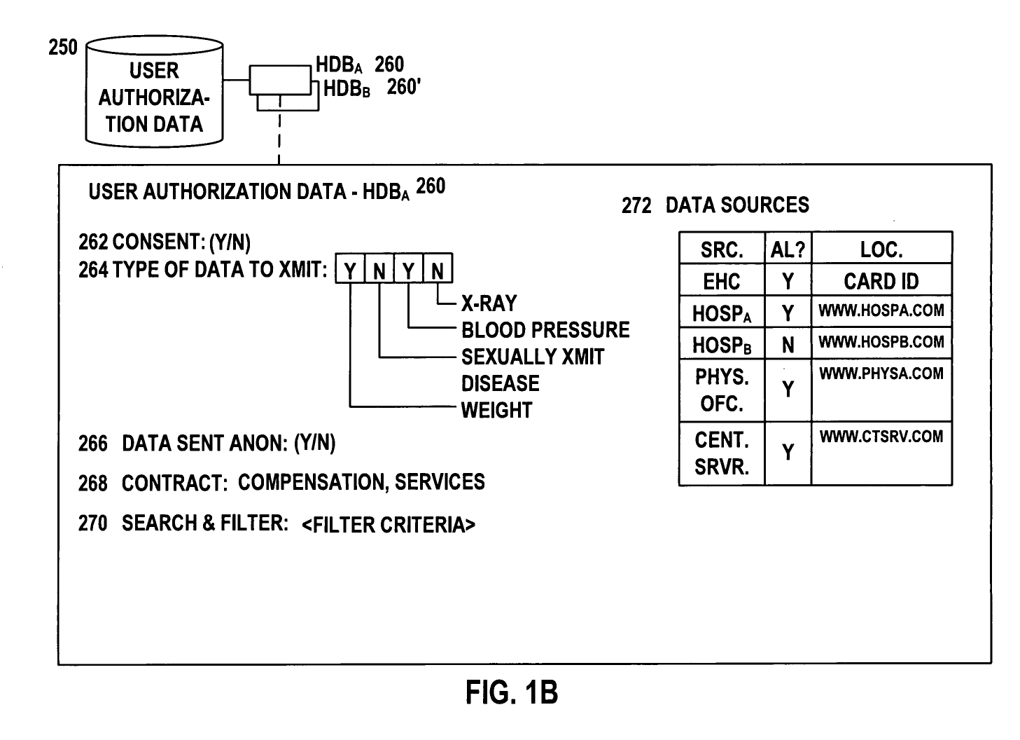

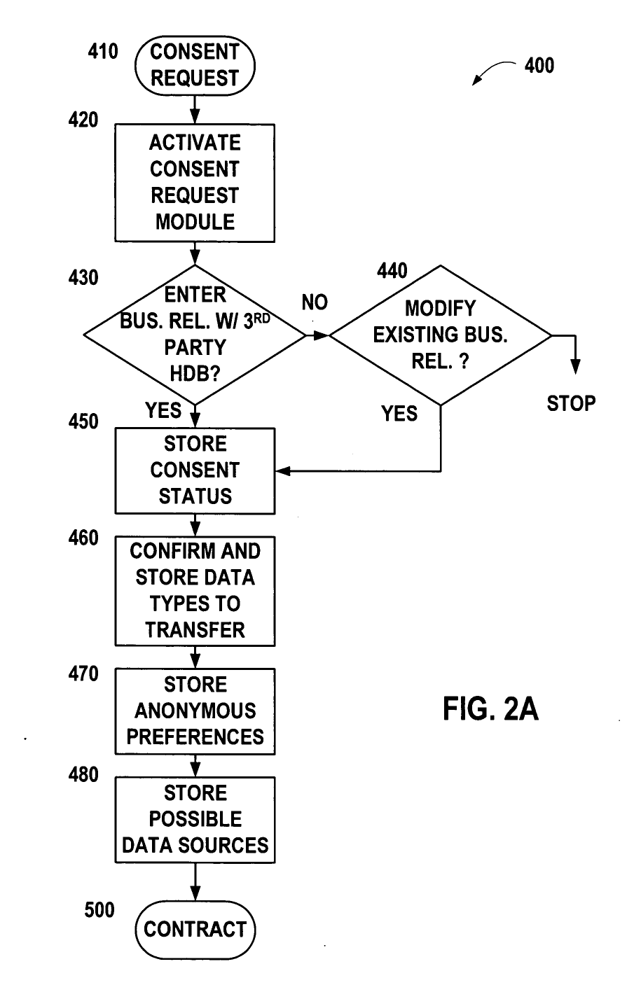

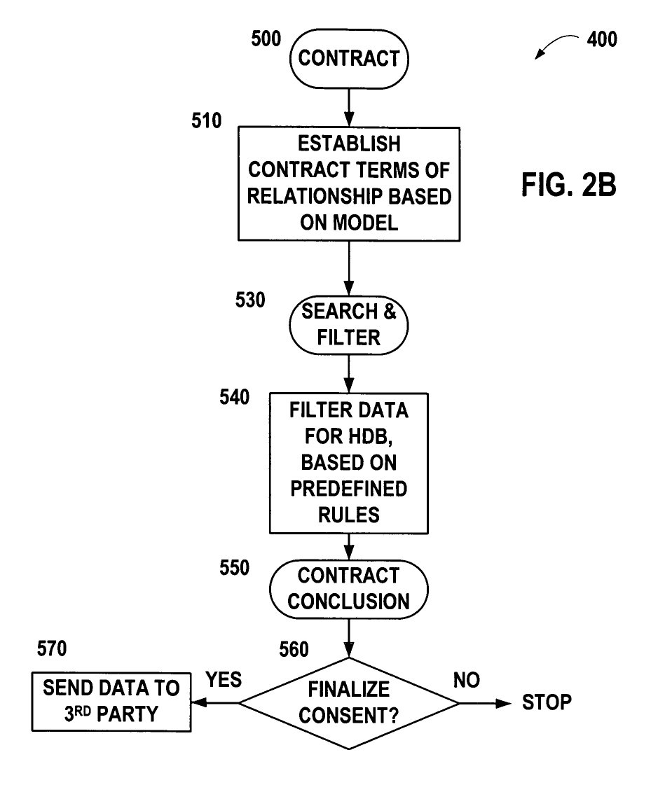

Various embodiments of the invention are discussed below with respect to FIGS. 1A to 2B illustrating a respective system 10 and appertaining method 400 used according to an exemplary embodiment. The elements include: 1) a consent request module 110 and process 410 related to consent of the user to transfer medical data; 2) a contract module 120 and process 500 related to the conditions under which medical data is transferred; 3) a searching and filtering module 130 and process 530 related to accessing relevant medical data for a particular situation; and 4) an optional contract conclusion module 140 and process 550.

### Consent Request

Referring to FIG. 1A, the system 10 may make use of an electronic health card (EHC) 20 of a user who wishes to share user medical data 210, which may be in the form of electronic patient records (EPRs). These data may be distributed over many different locations. The EPR term is used generically herein and may refer to any accessible medical data of the user stored in any relevant format.

A consent request module 110 may be provided on the EHC 20 and provides functionality related to consent of the user for third-party access to medical records. The third-parties are referred to herein as health data businesses (HDB) 80, 80′. In addition to the consent request module 110 being implemented as a plug-in module on the EHC 20, it can also be implemented in a networked health data access point 30, a central server 70, or even on the user's computer 50. Note that the user's computer could be a desktop PC, laptop, mobile PDA or telephone, or any other computing device accessible to a user.

When implemented in the EHC embodiment, the consent request module 110 may be activated upon insertion of the EHC 20 in a card input 32 of the EHC reader 30. The flow diagram, FIG. 2A, illustrates the consent request procedure 410 in which the consent request module is activated 420. As indicated above, however, the activation of the consent request module 420 can be invoked by a user interacting with the EHC reader, web terminal, etc. 30 or the user's computer 50 by selecting an option presented on an appertaining display with, e.g., a mouse, keyboard, or other user input device 36. Note that the card input 32, display 34, user input 36, and communication link 38 may all be present on the user's computer 50 as well.

The user is prompted to determine if he wishes to enter a business relationship with a third party HDB 430. A display 34 presents information relating to one or more prospective HDB 80, 80′, which can be presented, e.g., as a pick list or other mechanism for presenting options to the user. Alternately, the user can provide identification information for a particular HDB 80 that he wishes to engage. The response is provided via the user input. In the event that the user would prefer to modify an existing business relationship 440, the user can respond “No”, or alternately, invoke a procedure for modifying an existing business relationship from the start. If neither of these options are desired, the process stops, or at least goes directly to a routine in which additional user medical data can be sent to the third party HDB 80. The data related to each HDB 80 may be stored in the user authorization data store 250 in HDB records 260, 260′ (FIG. 1B).

This query 430, 440 may be started each time the card 20 is inserted (or the consent request module 110 invoked), or may only be started once, and the consent for interest 262 stored permanently 450 on the card 20, the user's computer 50, or the central server 70, if the user's answer is yes. Conversely, if the user's answer is no, this may also be stored permanently 450 such that the plug-in 430, 440 is not initiated a second time. Although it is advantageous to store consent information for multiple HDBs 80, 80′ on the card, it is also possible to use a separate card for each HDB 80.

During this initiating request, the user may also be prompted to confirm which type of data 264 he is willing to transfer to a third party 460 (e.g., by selecting data categories from a checkbox list), and if the data are to be transferred in an anonymized manner 266 (which will be the standard case) or possibly personalized 470 (i.e., comprising personal information that may permit a positive association of the data with a particular person—which will be the case only in special situations). Note that FIG. 1B illustrates an association of the field indicating whether data is to be sent anonymously 266 for the entire HDB record 260, however, nothing precludes associating an anonymous tag with each type of data to transmit 264 or each data source 272.

Additionally, the patient/user may receive, via the display 34, a request to identify possible data sources (e.g., the EHC itself, EPR data in Hospital A or B, EPR data from a physicians office, a central server 70, etc.). The user can further provide an access location for the respective data source 272. As illustrated in FIG. 1B, a list of all possible data sources 272 of the user's medical data can be provided and the user simply indicates whether a particular data source is allowed for this particular HDB 80. As indicated for HDBA in the figure, access to all data sources except HOSP_{B} is allowed. Furthermore, the type of data to transmit 264 may also be associated with each of the data sources 272. Once the data sources 272 are identified, they are stored 480.

### Contract

A second functionality of the system is a contract module 120 and appertaining process 500, which defines and regulates the conditions under which the data and use rights for the data are transferred to the interested third party 80. Such conditions can also dictate the compensation of the user for the transfer of data. This compensation may be purely financial, or e.g., a discount on health insurance fees, additional services, etc.

Although it is possible for the user to define the contract terms for the data transfer from scratch, in a preferred embodiment, the user is presented with a template or model contract in order to establish the contract terms 510. This model can present to the user commonly used options in general or can even present commonly used options for a particular HDB 80. Default values may be provided for the various components of the contract, and possible options for each component, which may be selected or de-selected by the user.

At this stage, the consent to this contract is of model character, meaning that it regulates the conditions under which data are transferred in general. But a finalization of the consent for the transaction may be necessary to be given by the user once actual data are to be transferred and the actual user for these data are identified. The contract information 268 may then be stored along with the user authorization data record 260.

### Search and Filter

The third functionality implemented in the system is a search and filter module 130 and appertaining process 530 that comprises, as the name would suggest, a search filter for relevant medical data. This search filter 130 may be automatically activated once the user has given consent to a potential HDB 80. From the initial interaction with the consent request module 110, the search filter module 130 receives information on the data sources 272 allowed for a search, including, e.g., the physical links to the data sources, and (possibly limited) authorization information for access to the data.

In the search filter module 130, one or more rules 270 for identification of relevant data may be implemented. These rules 270 can comprise e.g., a certain ICD code, an HL7 message, a Dicom Header entry, or even keywords for a free text search, or any combination thereof. One or more of these rules 270 may then be executed on the authorized data sources 272, and any data that are compliant with one or more of the rules 270 are identified. A search filter rule 270 may also contain information on the possible third party recipient HDB 80 of the data.

### Contract Conclusion

An optional further functionality provided is the contract conclusion module 140, and appertaining process 550. Once the data of interest have been identified by the search filter rule 270, the type and amount of data is presented to the user on the display 34, optionally together with information on the recipient HDB 80, and the user can then finally confirm 560 whether or not he is willing to sell use rights for these data to this recipient HDB 80. If the transaction is acceptable to the user, the data is then sent 570 to the recipient HDB 80. The transfer of data can be implemented in either a push manner, wherein the data is collected and then sent to a predetermined collection point of the HDB 80, or, alternately, the transfer of data can be implemented in a pull manner, wherein the HDB 80 is provided with access locations and instructions for obtaining the data. This procedure may take place immediately in the same interaction session with the EHC reader 30, if the data pool to be searched is immediately accessible and the evaluation takes only a short time. In another implementation scenario, the search filter module 130 is continuously or periodically active, searching in the authorized data sources 272, and the user is asked for final consent to search results 560 each time he is interacting with a EHC reader 30 (or any other interaction terminal within the networked Health Care System IT).

In another embodiment of the invention, the described system for a health care data business may alternatively be implemented as a Web based service 70, which may or may not use the EHC 20, and may simply require access to a web server, or may implement a client-server architecture wherein the user runs a client application on his computer 50 that interacts with the server 70. In this case all software modules mentioned above are implemented as Web accessible applications, or possibly as modules on the user's computer 50. The user can access his personal networked health data using the EHC 20 or any other authorization mechanism at any time. Whenever the user accesses his data, “the health data banking application” is executed in an equivalent manner as described above with the access through an EHC reader 30.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for authorizing transfer of and transmitting patient medical data by an owner of the data to a third party, comprising:
initiating a consent request to the owner of the medical data to provide patient medical data to a third party;
storing information related to the third party;
storing information related to a location of the medical data which are to be transferred to the third party;
storing information related to access authorization of the medical data which are to be transferred to the third party;
electronically creating a contract having terms defining and regulating conditions for use rights of the third party for the medical data and defining compensation for use of the medical data;
storing the contract terms;
searching and filtering for relevant patient medical data consistent with the contract terms, thereby producing filtered medical data; and
transmitting the filtered medical data to the third party.

2. The method according to claim 1, wherein initiating the consent request comprises inserting an electronic health card (EHC) into a card reader; and the storing of at least part of the information is done in a storage area of the EHC.

3. The method according to claim 2, wherein the card reader is a part of a networked health data access point.

4. The method according to claim 2, wherein the card reader is a part of a user computing device.

5. The method according to claim 1, wherein initiating the consent request comprises manually activating a consent request module on a networked health data access point, user computing device, or central server.

6. The method according to claim 1, wherein the storing of at least part of the information is done in a storage area of at least one of a user computing device and a central server.

7. The method according to claim 1, wherein the information related to a location of the medical data comprises an identification of a physical link to the medical data and access information needed to access the medical data.

8. The method according to claim 1, wherein creating the contract comprises:
providing a predefined contract template containing changeable default values.

9. The method according to claim 1, wherein creating the contract comprises:
presenting a list of possible contract options to the owner; and
selecting, by the owner, desired options.

10. The method according to claim 1, wherein the searching and filtering is performed automatically once the user gives consent.

11. The method according to claim 1, further comprising:
entering and storing a type of data to transmit.

12. The method according to claim 11, wherein the type of data to transmit is selected from a predefined list.

13. The method according to claim 1, further comprising:
entering and storing whether the data are to be sent anonymously or not; and
including identification information in the transmitting of the filtered medical data if the data is not to be sent anonymously.

14. The method according to claim 1, further comprising:
reviewing, by the owner, the filtered medical data and, in a contract conclusion, authorizing a release of the filtered medical data to the third party.

15. The method according to claim 1, wherein the search filter is continuously or periodically active.

16. A system for authorizing and transmitting patient medical data by an owner of the data to a third party, comprising:
a user input device, and a user display device;
a consent request module that is provided with information related to the third party via which the owner enters information related to user authorization data;
an owner medical data store comprising medical data associated with the owner;
a user authorization data store comprising the user authorization data entered by the user;
a contract module via which the owner enters contract terms and conditions for the third party;
a search and filter module comprising rules for filtering the owner medical data and a mechanism for accessing the filtered medical data from the owner medical data store; and
a communications link via which the third party accesses the filtered medical data.

17. The system according to claim 16, further comprising:
a contract conclusion module that presents the filtered medical data to the owner on a display and obtains owner consent for transmitting the filtered medical data via a user input.

18. The system according to claim 16, further comprising:
an electronic health card (EHC) that comprises the user authorization data;
a card input on a networked health data access point or a user computer that accepts the EHC.

19. The system according to claim 19, wherein the EHC comprises the consent request module, the contract module and the contract conclusion module.

20. The system according to claim 16, further comprising a central server that comprises the consent request module, the contract module, and the contract conclusion module and a network interface to the user input device and the user display device.

21. The system according to claim 16, further comprising:
a storage area comprising predefined contracts that are presented to the owner with the contract module.

22. The system according to claim 21, wherein the predefined contracts comprise default values that are presented to the owner.

23. The system according to claim 21, wherein the predefined contracts comprise a list of options that are available for contract terms.

24. The system according to claim 16, wherein the user authorization data includes a consent field indicative of a consent to transfer data to the third party.

25. The system according to claim 16, wherein the user authorization data includes an indication of one or more types of data to transmit.

26. The system according to claim 16, wherein the user authorization data includes an indication of one whether to transmit data anonymously.

27. The system according to claim 16, wherein the user authorization data comprises a physical link to a location for accessing the medical sources.

28. The system according to claim 16, wherein the rules comprise at least one of an IDC code, an HL7 message, a Dicom header entry, and keywords for a free text search.
